(19) United States
(12) Patent Application Publication
(10) Pub. No.: US 2010/0103507 A1
(43) Pub. Date: Apr. 29, 2010

(54) VISIBLE LIGHT-SHIELDING SILICONE RUBBER COMPOSITION, CURED PRODUCT, AND OPTOELECTRONIC DEVICE

(75) Inventors: Katsuyuki IMAZAWA, Annaka-shi (JP); Tsutomu Kashiwagi, Annaka-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Shin-Etsu Chemical Co., Ltd, Chiyoda-ku (JP)

(21) Appl. No.: 12/582,000

(22) Filed: Oct. 20, 2009

(30) Foreign Application Priority Data
Oct. 24, 2008 (JP) 2008-273764

(51) Int. Cl. G02B 5/20; G02B 5/23

(52) U.S. Cl. 359/350; 252/586

(57) ABSTRACT

A visible light-shielding silicone rubber composition is provided comprising (A) an organopolysiloxane, (B) an organohydrogenpolysiloxane, (C) a platinum catalyst, and (D) an azo dye. The azo dye has a light transmittance≦10% in a wavelength range of up to 650 nm and ≧80% in a wavelength range of at least 750 nm when a solution of the azo dye in ethanol is measured by a spectrophotometer. The composition cures into a film which shields visible light, but transmits IR light and is suited for encapsulation of LED.

### CROSS-REFERENCE TO RELATED APPLICATION

This non-provisional application claims priority under 35 U.S.C. S119(a) on Patent Application No. 2008-273764 filed in Japan on Oct. 24, 2008, the entire contents of which are hereby incorporated by reference.

### TECHNICAL FIELD

This invention relates to a visible light-shielding silicone rubber composition which cures into a product having high light-shielding properties in the visible spectrum and is suited for the encapsulation of optoelectronic devices, and an optoelectronic device encapsulated with the composition in the cured state.

### BACKGROUND ART

Traditionally, light-emitting diodes (LED) are covered or encapsulated at least on their emission output surface with a resin for providing surface protection and emission efficiency. In the case of IR light-emitting diodes, the resin used is loaded with a visible light-shielding filler for preventing any drop of emission efficiency by incidence of visible light from the exterior. In the prior art, epoxy resin compositions are widely used as the encapsulating resin.

However, LEDs encapsulated with epoxy resins generally have the drawback that they are sensitive to strains. This drawback becomes more serious in the current situation where LEDs of larger size are manufactured. More particularly, when epoxy resins cure, internal stresses can be generated by shrinkage, deformation or the like, to form cracks at the interface with the emission output surface. Formation of such cracks detracts from moisture resistance even if they are minute, and causes a failure over a long service period.

There is a need for a resin composition which is visible light shielding and low elastic.

Citation List

Patent Document 1: JP 3241338

Patent Document 2: JP-A H07-025987

### SUMMARY OF INVENTION

An object of the invention is to provide a visible light-shielding silicone rubber composition which cures into a crack-free film having good shielding properties in the visible spectrum and good transmitting properties in the IR spectrum and is suited for the encapsulation of LEDs, and an optoelectronic device encapsulated with the composition in the cured state.

In one aspect, the invention provides a visible light-shielding silicone rubber composition comprising (A) an organopolysiloxane containing at least two aliphatic unsaturated bonds in a molecule and having a viscosity of 10 to 100,000 mPa-s at 25° C., (B) an organohydrogenpolysiloxane, (C) a platinum group metal catalyst, and (D) an azo dye having a light transmittance of up to 10% in a wavelength range of up to 650 nm and at least 80% in a wavelength range of at least 750 nm, as measured by a transmittance measurement method, the transmittance measurement method including the steps of mixing the azo dye with ethanol in a weight ratio of 5:100, and measuring the transmittance of the mixture by a spectrophotometer.

The inventors have found that when the azo dye having good shielding properties in the visible portion of the spectrum and a high transmittance in the IR portion of the spectrum is compounded in a light-transmissive silicone rubber composition, a cured product (or film) resulting from curing of the composition has good shielding properties as demonstrated by a 650-nm light transmittance of up to 5% and very high transparency as demonstrated by a 800-nm light transmittance of at least 80%, at a thickness of 1.0 mm. By virtue of the low shrinkage factor and low expansion of silicone rubber, the silicone rubber composition with which an optoelectronic device is encapsulated is effective in preventing crack formation and any damage to the optoelectronic member.

The invention also provides a cured product obtained by curing the silicone rubber composition. The cured product has a 650-nm light transmittance of up to 5% of and a 800-nm light transmittance of at least 80% at a thickness of 1.0 mm.

In a further aspect, the invention provides an optoelectronic device encapsulated with the silicone rubber composition in the cured state.

### ADVANTAGEOUS EFFECTS OF INVENTION

The visible light-shielding silicone rubber composition of the invention cures into a crack-free film having good shielding properties in the visible spectrum and good transmitting properties in the IR spectrum. The composition is suited for the encapsulation of LEDs.

### BRIEF DESCRIPTION OF DRAWINGS

FIG. 1 is a diagram showing the light transmittance versus wavelength of the cured films of Examples 1 to 3 and Comparative Example 1.

### DESCRIPTION OF EMBODIMENTS

### A. Aliphatic Unsaturation-Containing Organopolysiloxane

Component (A) serving as a base component in the silicone rubber composition of the invention is an aliphatic unsaturation-containing organopolysiloxane. It may be any organopolysiloxane which contains at least two aliphatic unsaturated bonds such as vinyl and allyl groups in a molecule. Those organopolysiloxanes represented by the general formula (1) below and having a viscosity at 25° C. of 10 to 100,000 mPa-s, preferably 100 to 10,000 mPa-s are desirable for ease of working and curing. Those organopolysiloxanes containing 5 to 35 mol % of phenyl groups based on the total of entire substituent groups are more preferred for compatibility with the dye. It is noted that the viscosity is as measured by a rotational viscometer.

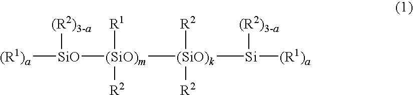

In formula (1), R¹ which may be the same or different is a substituted or unsubstituted monovalent hydrocarbon group containing an aliphatic unsaturated bond, specifically aliphatic unsaturated double bond, preferably of 2 to 6 carbon atoms, more preferably of 2 to 4 carbon atoms, “a” is an integer of 1 to 3, k and m each are 0 or a positive integer. Examples of the unsubstituted monovalent hydrocarbon group containing an aliphatic unsaturated bond, represented by R¹, include alkenyl groups such as vinyl, allyl, propenyl, and butenyl, with vinyl and allyl being most preferred.

R² which may be the same or different is a substituted or unsubstituted monovalent hydrocarbon group free of an aliphatic unsaturated bond. Examples of the unsaturation-free hydrocarbon group include alkyl groups such as methyl, ethyl, propyl and butyl, cycloalkyl groups such as cyclohexyl, aryl groups such as phenyl, tolyl and xylyl, aralkyl groups such as benzyl, and substituted forms of the foregoing groups in which some or all hydrogen atoms are substituted by halogen atoms, cyano groups or the like, such as chloromethyl, cyanoethyl and 3,3,3-trifluoropropyl. Inter alia, those hydrocarbon groups of 1 to 10 carbon atoms, especially 1 to 6 carbon atoms are preferred.

The subscript “a” is an integer of 1 to 3, preferably 1 or 2, and most preferably 1. The subscripts k and m each are 0 or a positive integer, and preferably such a number that the viscosity at 25° C. may fall in the above-specified range. In general, k and m are integers satisfying the range: 0<k+m≦10,000, preferably 30≦k+m≦2,000 and 0≦m/(k+m)≦0.2, and more preferably 50≦k+m≦1,000 and 0≦m/(k+m)≦0.1. Typical examples of the organopolysiloxane include those of the following formulae, but are not limited thereto.

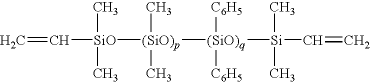

(Herein p and q are positive integers satisfying 10≦p+q≦1,000, preferably 50≦p+q≦500, and 0<q/(p+q)≦0.2.)

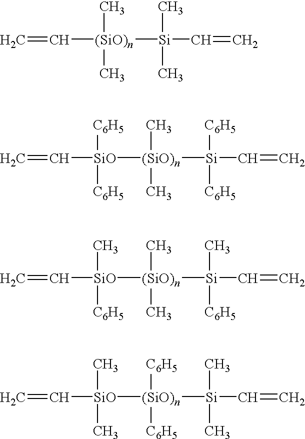

(Herein n is an integer of 1 to 1,000, preferably 10 to 500.)

### B. Organohydrogenpolysiloxane

Component (B) is an organohydrogenpolysiloxane which serves as a crosslinker. A cured product forms as addition reaction takes place between SiH groups in component (B) and aliphatic unsaturated groups (typically vinyl) in component (A). It is an organohydrogenpolysiloxane having at least two silicon-bonded hydrogen atoms (specifically 2 to 300 SiH groups), preferably at least three SiH groups (specifically 3 to 200 SiH groups), and more preferably 4 to 100 SiH groups, in a molecule, as represented by the average compositional formula (2):

Hₐ(R³)_{b}SiO_{(4-a-b)/2} (2)

wherein R³ which may be the same or different is a substituted or unsubstituted monovalent hydrocarbon group free of an aliphatic unsaturated bond, “a” and “b” are numbers in the range: 0.001≦a<2, 0.7≦b≦2, and 0.8≦a+b≦3.

In formula (2), R³ is a substituted or unsubstituted hydrocarbon group free of an aliphatic unsaturated bond, preferably of 1 to 10 carbon atoms, more preferably 1 to 7 carbon atoms, examples of which include lower alkyl groups such as methyl, aryl groups such as phenyl, and those exemplified for R¹ in formula (1). The subscripts “a” and “b” are numbers in the range: 0.001≦a<2, 0.7≦b≦2, and 0.8≦a+b≦3, and preferably in the range: 0.05≦a≦1, 0.8≦b≦2, and 1≦a+b≦2.7. A hydrogen atom may bond to a silicon atom at any desired position, namely at an end or an intermediate position of the molecule.

The number of silicon atoms per molecule, i.e., degree of polymerization may be in the range of 2 to 300, preferably 3 to 200, and more preferably 3 to 100.

Examples of the organohydrogenpolysiloxane include both end trimethylsilyl-capped methylhydrogenpolysiloxane, both end trimethylsilyl-capped dimethylsiloxane/methylhydrogensiloxane copolymers, both end dimethylhydrogensilyl-capped methylhydrogenpolysiloxane, both end dimethylhydrogensilyl-capped dimethylsiloxane/methylhydrogensiloxane copolymers, tetramethyltetrahydrogencyclotetrasiloxane, pentamethyltrihydrogencyclotetrasiloxane, and tri(dimethylhydrogensiloxane)methylsilane.

The molecular structure of the organohydrogenpolysiloxane may be either straight, branched, cyclic or network. These organohydrogenpolysiloxanes may generally be prepared by hydrolysis of chlorosilanes such as R³SiHCl₂, (R³)₃SiCl, (R³)₂SiCl₂, and (R³)₂SiHCl wherein R³ is as defined above, and optionally equilibration of the siloxane resulting from hydrolysis.

An amount of the organohydrogenpolysiloxane (B) blended is an amount effective for curing of component (A), typically such an amount as to give 0.1 to 4.0 moles, preferably 1.0 to 3.0 moles, and more preferably 1.2 to 2.8 moles of SiH groups per mole of entire aliphatic unsaturated groups (e.g., vinyl) in component (A). On this basis, with less than 0.1 mole of SiH groups, curing reaction may take place little, failing to produce a cured product or silicone rubber. With more than 4.0 moles of SiH groups, a cured product may have a more number of unreacted SiH groups left therein, which cause changes with time of rubber physical properties.

### C. Platinum Group Metal Catalyst

The catalyst component is compounded for promoting addition curing reaction in the inventive composition. Although platinum, palladium and rhodium catalysts are included, the platinum catalysts are preferred from the standpoint of cost. Exemplary platinum catalysts include H₂PtCl₆.mH₂O, K₂PtCl₆, KHPtCl₆.mH₂O, K₂PtCl₄, K₂PtCl₄.mH₂O, and PtO₂.mH₂O wherein m is a positive integer, and complexes thereof with hydrocarbons, alcohols and vinyl-containing organopolysiloxanes. The catalysts may be used alone or in admixture. The catalyst may be used in a catalytic amount, specifically in an amount to give 0.1 to 500 ppm, preferably 0.5 to 100 ppm of platinum group metal based on the weight of components (A) and (B) combined.

### D. Azo Dye

According to the invention, an azo dye is compounded in a silicone rubber composition comprising the foregoing components (A) to (C). The azo dye should have a light transmittance of up to 10%, especially up to 5% in a wavelength range of up to 650 nm and at least 80%, especially at least 85% in a wavelength range of at least 750 nm, as measured by a transmittance measurement method, the transmittance measurement method including the steps of dissolving the azo dye in ethanol in a weight ratio of 5:100, and measuring the transmittance of the ethanol solution at 23° C. by a spectrophotometer.

The azo dyes used herein include ordinary azo dyes and azo-chrome dyes although the azo dyes which have appropriate shielding properties in the visible portion (i.e., 400 to 700 nm) of the spectrum are preferred. Non-limiting examples of the azo dye that satisfies a specific transmittance as measured by the above-defined method include Kayaset Black 151-H (a light transmittance of 5% in a wavelength range of up to 650 nm and 85% in a wavelength range of at least 750 nm) and PC Black 006P (a light transmittance of 10% in a wavelength range of up to 650 nm and 80% in a wavelength range of at least 750 nm), both available from Nippon Kayaku Co., Ltd.

The azo dye may be added in an amount of 0.1 to 10 parts, more preferably 0.2 to 5 parts by weight per 100 parts by weight of component (A) whereby the composition is endowed with satisfactory visible light-shielding properties.

### Other Components

In addition to the foregoing components, if desired, a variety of additives which are per se known may be compounded in the invention composition. For example, reinforcing inorganic fillers such as fumed silica and fumed titanium dioxide and non-reinforcing inorganic fillers such as calcium carbonate, calcium silicate, titanium dioxide, ferric oxide, carbon black and zinc oxide may be compounded in a suitable amount of up to 100 parts by weight per 100 parts by weight of components (A) and (B) combined.

If desired, any other components may be compounded in the invention composition insofar as the objects and effects of the invention are not compromised. Suitable other components which can be compounded herein include addition reaction regulators, adhesion-imparting components such as alkoxysilanes, and silane coupling agents.

### Silicone Rubber Composition

The silicone rubber composition of the invention may be prepared by mixing the foregoing components until uniform. Most often, the composition is divided in two parts for storage so as to prevent any progress of cure during storage. On use, two parts are mixed together and allowed to cure. The composition may be prepared as one part if a small amount of a cure inhibitor such as acetylene alcohol is added. The composition cures immediately, if necessary, by heating. Thus the composition finds use as a protective coating agent on electric and electronic parts, as potting, casting and molding compounds, and in applications where silicone's adhesiveness is undesired, typically keyboard surface coatings.

The composition is generally cured by heating at 80 to 180° C. for 30 minutes to 6 hours, and preferably at 100 to 160° C. for 1 to 4 hours.

The composition comprising components (A) to (D) cures into a silicone rubber (cured product) which has very good light-shielding properties as demonstrated by a 650-nm light transmittance of up to 5% and very high transparency as demonstrated by a 800-nm light transmittance of at least 80%, both at a thickness of 1.0 mm. By virtue of the low shrinkage factor and low expansion of silicone rubber, the silicone rubber composition, when used in encapsulation of an optoelectronic device, is effective in preventing crack formation and any damage to the optoelectronic member.

### EXAMPLE

Examples of the invention are given below by way of illustration and not by way of limitation. All parts are by weight. The viscosity is measured at 25° C. by a rotational viscometer.

### Example 1

A silicone rubber composition was prepared by combining 100 parts of a polysiloxane of the formula:

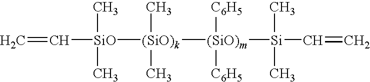

wherein k=68 and m=30, having a viscosity of ˜4,000 mPa-s, with an organohydrogenpolysiloxane of the formula:

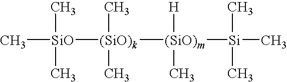

wherein k=10 and m=8, in an amount to give 1.5 moles of SiH groups per mole of total vinyl groups in the polysiloxane, 0.05 part of an octyl alcohol-modified chloroplatinic acid solution, and 2 parts of Kayaset Black 151-H (Nippon Kayaku Co., Ltd.) and thoroughly agitating them. The composition was heat molded at 100° C. for 4 hours into a cured part. It was measured for tensile strength and hardness (Type A spring tester) according to JIS K-6301. Also, the cured part having a thickness of 1 mm was measured for light transmittance by a transmittance tester V-4100 (Hitachi Ltd.). At this time, the light transmittance in wavelength 650 nm was 0%, and the light transmittance in wavelength 800 nm was 96%.

A bare light-emitting diode member was filled with the composition, which was heated at 100° C. for 4 hours. The sample was subjected to thermal cycling between −40° C. for 30 minutes and 150° C. for 30 minutes. After 500 cycles, the interface between the emission output surface and the composition was observed for cracks, from which a percent crack formation was determined (10 samples).

### Example 2

A silicone rubber composition was prepared by combining 100 parts of a polysiloxane of the formula:

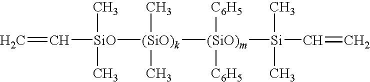

wherein k=83 and m=15, having a viscosity of ˜2,000 mPa-s, with an organohydrogenpolysiloxane of the formula:

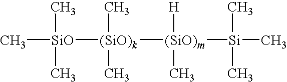

wherein k=10 and m=8, in an amount to give 1.5 moles of SiH groups per mole of total vinyl groups in the polysiloxane, 0.05 part of an octyl alcohol-modified chloroplatinic acid solution, and 2 parts of Kayaset Black 151-H (Nippon Kayaku Co., Ltd.) and thoroughly agitating them. The composition was heat molded at 100° C. for 4 hours into a cured part (thickness: 1.0 mm). It was similarly measured for tensile strength and hardness according to JIS K-6301 and for light transmittance. At this time, the light transmittance in wavelength 650 nm was 0%, and the light transmittance in wavelength 800 nm was 95%.

A bare LED member was filled with the composition, which was heated at 100° C. for 4 hours. The sample was subjected to thermal cycling between −40° C. for 30 minutes and 150° C. for 30 minutes. After 500 cycles, the interface between the emission output surface and the composition was observed for cracks, from which a percent crack formation was determined (10 samples).

### Example 3

A silicone rubber composition was prepared by combining 100 parts of a polysiloxane of the formula:

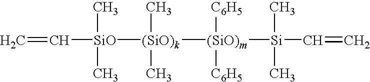

wherein k=68 and m=30, having a viscosity of ˜4,000 mPa-s, with an organohydrogenpolysiloxane of the formula:

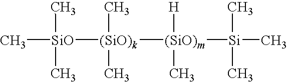

wherein k=10 and m=8, in an amount to give 1.5 moles of SiH groups per mole of total vinyl groups in the polysiloxane, 0.05 part of an octyl alcohol-modified chloroplatinic acid solution, and 2 parts of azo-chrome dye PC Black 006P (Nippon Kayaku Co., Ltd.) and thoroughly agitating them. The composition was heat molded at 100° C. for 4 hours into a cured part (thickness: 1.0 mm). It was similarly measured for tensile strength and hardness according to JIS K-6301 and for light transmittance. At this time, the light transmittance in wavelength 650 nm was 5%, and the light transmittance in wavelength 800 nm was 81%.

A bare LED member was filled with the composition, which was heated at 100° C. for 4 hours. The sample was subjected to thermal cycling between −40° C. for 30 minutes and 150° C. for 30 minutes. After 500 cycles, the interface between the emission output surface and the composition was observed for cracks, from which a percent crack formation was determined (10 samples).

### Comparative Example 1

A silicone rubber composition was prepared by combining 100 parts of a both end vinyldimethylsiloxy-capped dimethylpolysiloxane having a viscosity of ˜5,000 mPa-s with 1.5 parts of a both end dimethylhydrogensiloxy-capped dimethylsiloxane/methylhydrogensiloxane copolymer (degree of polymerization ˜15, SiH group ˜0.007 mol/g), 0.1 part of an octyl alcohol-modified chloroplatinic acid solution, and 1 part of Oil Black CB-10 and thoroughly agitating them. The composition was heat molded at 100° C. for 4 hours into a cured part (thickness: 1.0 mm). It was similarly measured for tensile strength and hardness according to JIS K-6301 and for light transmittance. At this time, the light transmittance in wavelength 650 nm was 18%, and the light transmittance in wavelength 800 nm was 67%.

A bare LED member was filled with the composition, which was heated at 100° C. for 4 hours. The sample was subjected to thermal cycling between ˜40° C. for 30 minutes and 150° C. for 30 minutes. After 500 cycles, the interface between the emission output surface and the composition was observed for cracks, from which a percent crack formation was determined (10 samples).

### Comparative Example 2

An epoxy resin composition was prepared by combining 25 parts of Epikote® YX8000 (bisphenol A type epoxy resin, Japan Epoxy Resin Co., Ltd.) with 22.5 parts of Rikacid® MH700 (4-methylhexahydrophthalic anhydride, New Japan Chemical Co., Ltd.) and 1 part of Oil Black CB-10, melt mixing at 70° C. for 30 minutes, adding 0.25 part of Curezol® 2E4MZ-CN (Shikoku Chemicals Corp.), and mixing at 70° C. for 10 minutes.

A bare LED member was filled with the epoxy resin composition, which was heated at 100° C. for 4 hours. The sample was subjected to thermal cycling between ˜40° C. for 30 minutes and 150° C. for 30 minutes. After 500 cycles, the interface between the emission output surface and the resin was observed for cracks, from which a percent crack formation was determined (10 samples).

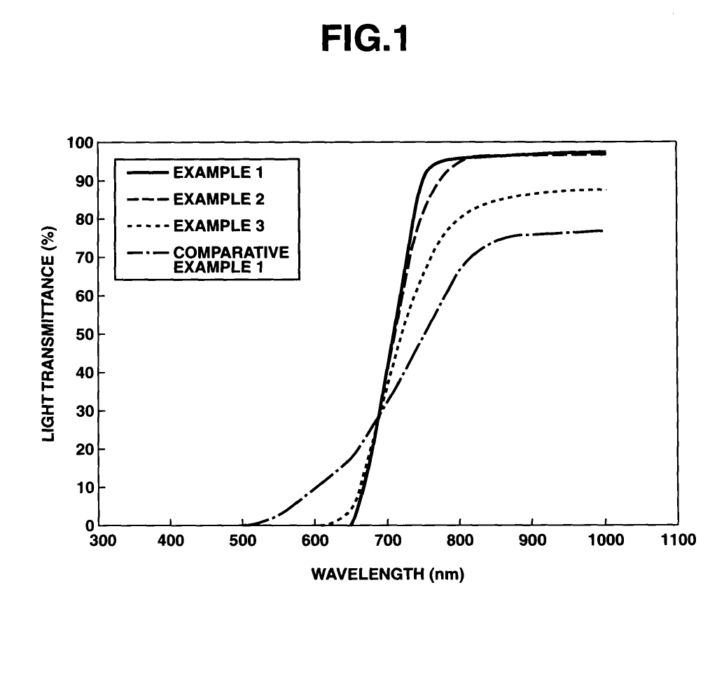

The data of light transmittance are plotted in the diagram of FIG. 1. The results of physical properties and crack formation are reported in Table 1.

TABLE 1

| | | | Comparative | |
|---|---|---|---|---|
| Example | | | Example | |
| 1 | 2 | 3 | 1 | 2 |

Curing conditions: 100° C./4 hr

| | | | | | |
|---|---|---|---|---|---|
| Tensile strength (MPa) | 0.12 | 0.14 | 0.20 | 0.32 | — |
| Hardness (JIS-A) | 14 | 12 | 16 | 20 | — |
| Crack formation (%) | 0 | 0 | 0 | 0 | 100 |

Japanese Patent Application No. 2008-273764 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A visible light-shielding silicone rubber composition comprising
(A) an organopolysiloxane containing at least two aliphatic unsaturated bonds in a molecule and having a viscosity of 10 to 100,000 mPa-s at 25° C.,
(B) an organohydrogenpolysiloxane,
(C) a platinum group metal catalyst, and
(D) an azo dye having a light transmittance of up to 10% in a wavelength range of up to 650 nm and at least 80% in a wavelength range of at least 750 nm, as measured by a transmittance measurement method, said transmittance measurement method including the steps of mixing the azo dye is with ethanol in a weight ratio of 5:100, and measuring the transmittance of the mixture by a spectrophotometer.

2. A cured product obtained by curing the visible light-shielding silicone rubber composition of claim 1, said cured product having a 650-nm light transmittance of up to 5% and a 800-nm light transmittance of at least 80% at a thickness of 1.0 mm.

3. An optoelectronic device encapsulated with the visible light-shielding silicone rubber composition of claim 1 in the cured state.
